(19) United States
(12) Patent Application Publication
(10) Pub. No.: US 2024/0339719 A1
(43) Pub. Date: Oct. 10, 2024

(54) BATTERY SYSTEM ENCLOSURE WITH VENTING CHANNEL(S) FOR THERMAL RUNAWAY MITIGATION

(71) Applicant: GM GLOBAL TECHNOLOGY OPERATIONS LLC, Detroit, MI (US)

(72) Inventors: Ran Wu, Lake Orion, MI (US); Xianfeng Yan, Clawson, MI (US); Matthew Simonin, Ortonville, MI (US)

(73) Assignee: GM GLOBAL TECHNOLOGY OPERATIONS LLC, Detroit, MI (US)

(21) Appl. No.: 18/297,703

(22) Filed: Apr. 10, 2023

(51) Int. Cl. H01M 50/367; B60L 50/64; H01M 50/249; H01M 50/271; H01M 50/30

(52) U.S. Cl. CPC H01M 50/367; B60L 50/64; H01M 50/249; H01M 50/271; H01M 50/394; H01M 2220/20

(57) ABSTRACT

A battery system includes neighboring first and second groups of battery cells. The battery system also includes a battery system enclosure configured to house each of the first and second groups of battery cells. The battery system additionally includes a vent channel mounted to the battery system enclosure. The vent channel is configured to expel high-temperature gases to external environment separately from each battery cell of the first group of battery cells and divert the high-temperature gases away from other battery cells of the first group of battery cells and from the second group of battery cells. The vent channel minimizes transfer of the high-temperature gases between the battery cells of the first group and from the first group of battery cells to the second group of battery cells and thereby mitigates propagation of a thermal runaway event in the battery system.

### INTRODUCTION

The present disclosure relates to a battery system enclosure with venting channel(s) configured to remove heat and mitigate a thermal runaway event in the battery system.

A battery cell array, such as a battery module, pack, etc., typically includes a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Such chemical reactions may cause more heat to be generated by the batteries than is effectively withdrawn. Exposure of a battery cell to elevated temperatures over prolonged periods may cause the cell to experience a thermal runaway event. Accordingly, a thermal runaway event starting within an individual cell may lead to the heat spreading to adjacent cells in the battery cell array and cause the thermal runaway event to affect the entire array.

### SUMMARY

A battery system includes a first group of battery cells and a neighboring second group of battery cells arranged in a battery set, such as a module or a pack. The battery system also includes a battery system enclosure surrounded by an external environment and configured to house each of the first group of battery cells and the second group of battery cells. The battery system additionally includes a vent channel mounted to the battery system enclosure. The vent channel is configured to expel high-temperature gases to the external environment separately from each battery cell of the first group of battery cells and divert the high-temperature gases away from other battery cells of the first group of battery cells and from the second group of battery cells. The vent channel is thereby configured to minimize transfer of the high-temperature gases between the battery cells of the first group of battery cells and from the first group of battery cells to the second group of battery cells and mitigate propagation of a thermal runaway event in the battery system.

The battery system enclosure may include a valve connected to the vent channel and configured to control expelling of the high-temperature gases from the vent channel to the external environment.

The battery system enclosure may also include an enclosure cover. In such an embodiment, the vent channel may be fixed to the enclosure cover to generate a bounded passage for the high-temperature gases.

The valve may be mounted to the enclosure cover.

The vent channel may be welded to the enclosure cover.

The enclosure may include an enclosure tray configured to connect with the enclosure cover. In such an embodiment, the vent channel may be mounted to the enclosure tray.

The battery system may further include a gasket arranged between the vent channel and the first group of battery cells.

The gasket may be constructed from silicon and configured to maintain contact with each of the vent channel and the first group of battery cells.

The vent channel may define a plurality of vent holes, each vent hole aligning with one battery cell of the first group of battery cells.

The vent channel may extend across each of the battery cells of the first group of battery cells. In a cross-sectional view, the vent channel may have a rectangular shape.

A motor vehicle having a power-source and the above-disclosed battery system configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a battery system having battery cells arranged in arrays configured to generate and store electrical energy.

FIG. 2 is a schematic side view of the battery array shown in FIG. 1, illustrating an array enclosure having a tray and a cover, according to the present disclosure.

FIG. 3 is a schematic perspective view of the battery array shown in FIG. 2, illustrating the array enclosure with the cover removed to expose battery cells and vent channels located under the cover and valves connected to the channels, according to the disclosure.

FIG. 4 is a schematic cross-sectional plan view of one of the vent channels shown in FIG. 3, additionally illustrating a gasket arranged between the cover and one of the battery cells, according to the disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

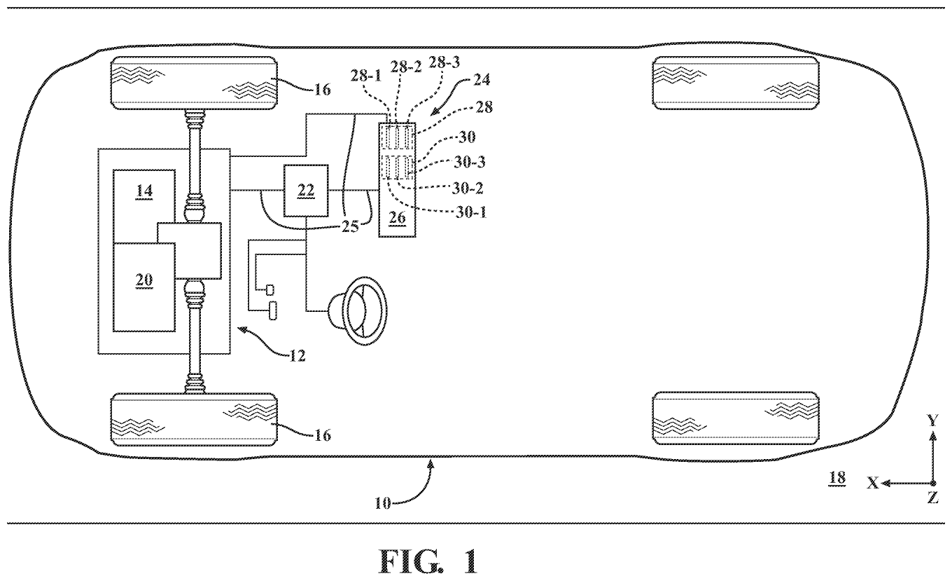

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a battery system 24 configured to generate and store electrical energy through heat-producing electro-chemical reactions for supplying the electrical energy to the power-sources 14 and 20. The electronic controller 22 may be a central processing unit (CPU) that regulates various functions of the vehicle 10, or as a powertrain control module (PCM) configured to control the powertrain 12 to generate a predetermined amount of power-source torque. The battery system 24 may be connected to the power-sources 14 and 20, the electronic controller 22, as well as other vehicle systems via a high-voltage BUS 25. Although the battery system 24 is described herein primarily with respect to a vehicle environment, nothing precludes the subject battery system from being employed to power other, non-automotive systems.

With continued reference to FIG. 1, the battery system 24 includes one or more sections or arrays 26 of individual battery cells with respect to an X-Y-Z coordinate system. Each battery cell array 26 may be configured as a battery module or a number of battery modules bundled into a battery pack. The array 26 includes a plurality of battery cells, such as a first group of battery cells 28 and a neighboring, directly adjacent, second group of battery cells 30, each extending generally upward, i.e., in the Z direction. Although one array 26 (illustrated as a battery pack) and two groups of battery cells 28, 30 (illustrated as individual modules) are specifically indicated, nothing precludes the battery system 24 from having a greater number of such arrays with a particular number of battery cells arranged therein. As shown, the first cell group 28 includes individual battery cells 28-1, 28-2, 28-3, while the neighboring second cell group 30 includes individual battery cells 30-1, 30-2, 30-3.

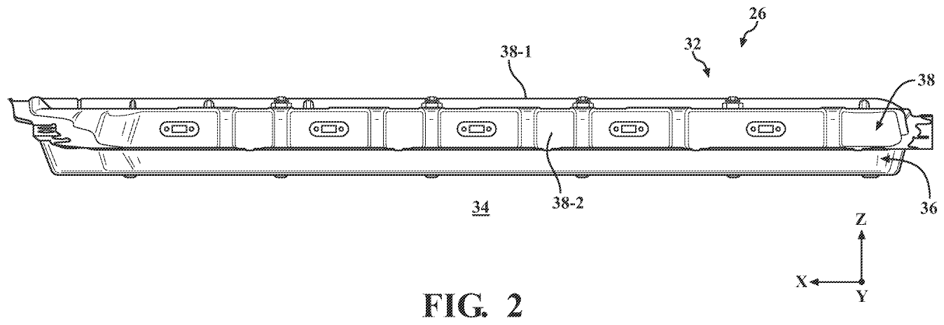

As shown in FIG. 2, the battery system 24 also includes a battery system enclosure 32 configured to house each of the first and second battery cell groups 28, 30. The battery system enclosure 32 is surrounded by an ambient environment 34, i.e., environment external to the battery system enclosure. The battery system enclosure 32 is configured to manage high-temperature gases emitted by battery cells in the cell groups 28, 30, such as during a battery cell thermal runaway event, and expel the high-temperature gases to the external environment 34. The battery system enclosure 32 includes an enclosure tray 36 and an enclosure cover 38. The enclosure cover 38 is generally positioned above the battery cells 28-1, 28-2, 28-3 and 30-1, 30-2, 30-3 and configured to engage the enclosure tray 36 to substantially seal the battery system enclosure 32 and its contents from the external environment 34. As shown, the battery system enclosure 32 is arranged in a horizontal X-Y plane, such that the enclosure cover 38 is positioned above the enclosure tray 36 when viewed along a Z-axis.

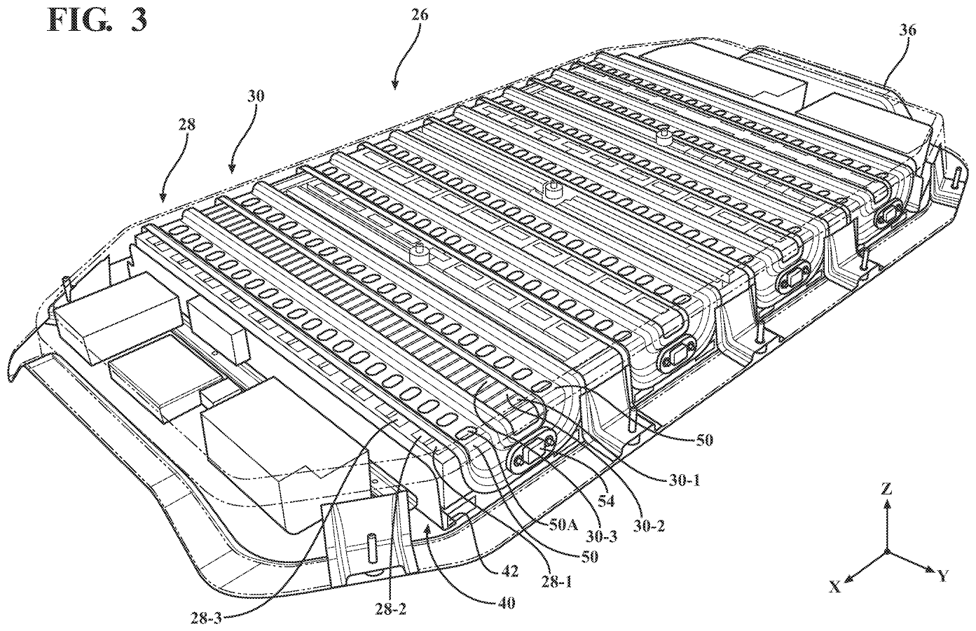

As shown in FIG. 3, the battery system 24 may also include a heat sink 40. The heat sink 40 is generally positioned below and in direct contact with the battery cells of the first and second battery cell groups 28, 30 to thereby absorb thermal energy from the respective battery cells. As shown, the heat sink 40 may be in direct physical contact with the battery cells of the first and second cell groups 28, 30. The heat sink 40 may be configured as a coolant plate having a plurality of coolant channels 42. The coolant channels 42 are specifically configured to circulate a coolant and thereby remove thermal energy from the first and second battery cell groups 28, 30 while the battery cell array 26 generates/stores electrical energy.

Generally, during normal operation of the battery cell array 26, the heat sink 40 is effective in absorbing thermal energy released by the first and second battery cell groups 28, 30. However, during extreme conditions, such as during a thermal runaway event, the amount of thermal energy released by the cell undergoing the event may saturate the heat sink 40 and exceed capacity of the battery cell array 26 to efficiently transfer heat, e.g., from the battery system enclosure 32 to the ambient environment 34. As a result, excess thermal energy will typically be transferred between the neighboring cells of each of the respective first and second battery cell groups 28, 30 and between the two groups, leading to propagation of the thermal runaway through the battery cell array 26. The term “thermal runaway event” generally refers to an uncontrolled increase in temperature in a battery system. During a thermal runaway event, the generation of heat within a battery system or a battery cell exceeds the dissipation of heat, thus leading to a further increase in temperature. A thermal runaway event may be triggered by various conditions, including a short circuit within the cell, improper cell use, physical abuse, manufacturing defects, or exposure of the cell to extreme external temperatures.

For example, in the event one battery cell in the first battery cell group 28, such as the cell 28-1, experiences the thermal runaway event 46, the excess gases generated by such an event would give rise to highly elevated internal cell pressures having tendency to rupture the casing of the subject cell. In the event of the battery cell 28-1 casing rupture, high-temperature gases 48 (with temperatures up to 1,500 degrees Celsius) emitted by the subject battery cell may send cell debris through the first battery cell group 28, triggering a thermal runaway of other battery cells 28-2, 28-3. Furthermore, the thermal runaway event 46 may spread from the first battery cell group 28 to the second battery cell group 30 and trigger thermal runaway of its battery cells 30-1, 30-2, 30-3. Accordingly, such transfer of high-temperature gases 48 typically increases the likelihood of a chain reaction in the battery cell array(s) 26, affecting a significant part of the battery system 24.

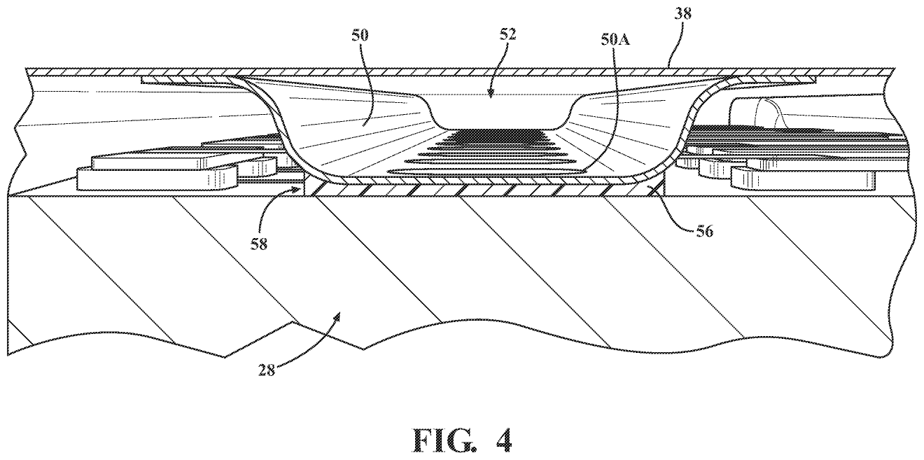

As shown in FIGS. 3 and 4, the battery system 24 additionally includes vent channels 50. Each of the vent channels 50 is generally arranged above one of the cell groups, e.g., the first and second battery cell groups 28, 30, between the respective cells and the enclosure cover 38. As shown, each vent channel 50 may extend across a row of battery cells in the respective first or second battery cell group 28, 30 and substantially parallel to an inner surface of the enclosure cover 38. For example, one vent channel 50 may extend across the battery cells, e.g., cells 28-1, 28-2, 28-3, of the first group 28 and another vent channel 50 may extend across the battery cells, e.g., cells 30-1, 30-2, 30-3, of the second group 30. Each vent channel 50 may define a plurality of vent holes 50A. The vent holes 50A are positioned to align with locations of battery cells 28-1, 28-2, 28-3 of the corresponding first group 28 or battery cells 30-1, 30-2, 30-3 of the corresponding second group 30. As may be seen in a cross-sectional view of the channel 50 depicted in FIG. 4, each vent channel may have a substantially rectangular shape 52.

The vent channels 50 are mounted to the battery system enclosure 32. The vent channels 50 may be fixed to the enclosure cover 38, thereby generating a bounded passage for the high-temperature gases 48. For example, the vent channels 50 may be welded or bolted to the enclosure cover 38. Alternatively, the vent channels 50 may be mounted, e.g., welded or bolted, to the enclosure tray 36. Each vent channel 50 is configured to expel the high-temperature gases 48 directly to the external environment 34, without permitting the gases to spread through the system enclosure 32, separately, i.e., individually and independently, from each battery cell of the respective first battery cell group 28. Similarly, another vent channel 50 is configured to expel the high-temperature gases 48 directly to the external environment 34 separately from each battery cell of the respective second battery cell group 30.

Overall, each vent channel 50 is configured to minimize the likelihood of high-temperature gases 48 being released uncontrollably into the interior of the battery system enclosure 32 during a thermal runaway of one or more of the constituent battery cells. Each vent channel 50 is specifically configured to divert the high-temperature gases 48 away from other battery cells in the corresponding group of battery cells 28 or 30, and also from another, adjacent group of battery cells. Such operation of the vent channels 50 is designed to minimize transfer of the high-temperature gases 48 between battery cells of the first group of battery cells 28 and between battery cells of the second group of battery cells 30. The vent channels 50 also minimize transfer of the high-temperature gases 48 between the first and second groups of battery cells, e.g., from the first group of battery cells to the second group of battery cells, to mitigate or control propagation of the thermal runaway event 46 in the battery cell array 26.

As shown in FIGS. 2 and 3, the battery system enclosure 32 may additionally include valves 54 connected to the vent channel 50. The valves 54 are configured to control expelling or discharging of the high-temperature gases 48 from the vent channels 50 to the external environment 34. One or more vent channels 50 may be connected or correspond to each valve 54. Each valve 54 may be mounted to the enclosure cover 38 and be configured as a one-way fluid exhaust device. The enclosure cover 38 may have a clamshell configuration, wherein a top cover surface 38-1 resides in the X-Y plane and cover sides or lateral sections 38-2 bend down from the top surface toward the enclosure tray 36 in the Z direction. Accordingly, as shown in FIG. 3, the vent channels 50 may extend parallel to the top cover surface 38-1 along the X-Y plane and bend down to remain parallel to the cover sides 38-2 along the Z-axis. As additionally shown, adjacent or neighboring vent channels 50 may fluidly connect in a region on at least one of the cover sides 38-2 and join at a common valve 54.

With continued reference to FIG. 3, the battery system 24 may also include one or more gaskets 56, which may be constructed as electrically nonconductive, resilient, high-temperature resistant sealing elements. For example, the gasket(s) 56 may be constructed from silicon. Each gasket 56 may be arranged in an interface 58 between one vent channel 50 and a corresponding one of the first and second groups 28, 30 of battery cells. The gaskets 56 are configured to maintain contact with each of the vent channel 50 and the corresponding first or second group 28, 30 of battery cells. In other words, each gasket 56 may be constructed and arranged to seal the interface 58 between individual battery cells in a particular cell group 28 or 30 and the vent channel 50 such that the high-temperature gases 48 released by one of the constituent battery cells are initially directed into the vent channel, rather than toward a neighboring cell. To facilitate ease of assembly of the battery system 24, the gasket 56 may be glued to the corresponding vent channel 50.

In summary, the vent channels 50 of the battery system enclosure 32 are arranged and shaped to collect high-temperature gases 48 released during a thermal runaway event by a battery cell in a respective battery group and guide such gases out of the enclosure to the ambient. Specifically, during operation of the battery system 24, the vent channels 50 expel high-temperature gases to the external environment separately from each battery cell and divert the gases away from other battery cells in the battery cell array(s) 26. The vent channels thereby minimize transfer of the high-temperature gases between individual battery cells and mitigate propagation of the thermal runaway event in the battery system 24. The battery array enclosure 32 may also include valves 54 fluidly connected to the vent channels 50 for controlling the discharge of high-temperature gases to the ambient.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery system comprising:
a first group of battery cells and a neighboring second group of battery cells;
a battery system enclosure surrounded by an external environment and configured to house each of the first group of battery cells and the second group of battery cells;
a vent channel mounted to the battery system enclosure and configured to expel high-temperature gases to the external environment separately from each battery cell of the first group of battery cells and divert the high-temperature gases away from other battery cells of the first group of battery cells and from the second group of battery cells, to thereby minimize transfer of the high-temperature gases between the battery cells of the first group of battery cells and from the first group of battery cells to the second group of battery cells and mitigate propagation of a thermal runaway event in the battery system.

2. The battery system of claim 1, wherein the battery system enclosure includes a valve connected to the vent channel and configured to control expelling of the high-temperature gases from the vent channel to the external environment.

3. The battery system of claim 2, wherein the battery system enclosure includes an enclosure cover, and wherein the vent channel is fixed to the enclosure cover.

4. The battery system of claim 3, wherein the valve is mounted to the enclosure cover.

5. The battery system of claim 3, wherein the vent channel is welded to the enclosure cover.

6. The battery system of claim 3, wherein the battery system enclosure includes an enclosure tray configured to connect with the enclosure cover, and wherein the vent channel is mounted to the enclosure tray.

7. The battery system of claim 1, further comprising a gasket arranged between the vent channel and the first group of battery cells.

8. The battery system of claim 7, wherein the gasket is constructed from silicon and configured to maintain contact with each of the vent channel and the first group of battery cells.

9. The battery system of claim 1, wherein the vent channel defines a plurality of vent holes, each vent hole aligning with one battery cell of the first group of battery cells.

10. The battery system of claim 1, wherein the vent channel extends across each of the battery cells of the first group of battery cells, and wherein, in a cross-sectional view, the vent channel has a rectangular shape.

11. A motor vehicle comprising:
a power-source configured to generate power-source torque; and
a battery pack configured to supply electrical energy to the power-source, the battery pack including:
a first group of battery cells and a neighboring second group of battery cells;
a battery pack enclosure surrounded by an external environment and configured to house each of the first group of battery cells and the second group of battery cells;
a vent channel mounted to the battery pack enclosure and configured to expel high-temperature gases to the external environment separately from each battery cell of the first group of battery cells and divert the high-temperature gases away from other battery cells of the first group of battery cells and from the second group of battery cells, to thereby minimize transfer of the high-temperature gases between the battery cells of the first group of battery cells and from the first group of battery cells to the second group of battery cells and mitigate propagation of a thermal runaway event in the battery pack.

12. The motor vehicle of claim 11, wherein the battery pack enclosure includes a valve connected to the vent channel and configured to control expelling of the high-temperature gases from the vent channel to the external environment.

13. The motor vehicle of claim 12, wherein the battery pack enclosure includes an enclosure cover, and wherein the vent channel is fixed to the enclosure cover.

14. The motor vehicle of claim 13, wherein the valve is mounted to the enclosure cover.

15. The motor vehicle of claim 13, wherein the vent channel is welded to the enclosure cover.

16. The motor vehicle of claim 13, wherein the battery pack enclosure includes an enclosure tray configured to connect with the enclosure cover, and wherein the vent channel is mounted to the enclosure tray.

17. The motor vehicle of claim 11, wherein the battery pack additionally includes a gasket arranged between the vent channel and the first group of battery cells.

18. The motor vehicle of claim 11, wherein the vent channel defines a plurality of vent holes, each vent hole aligning with one battery cell of the first group of battery cells.

19. The motor vehicle of claim 11, wherein the vent channel extends across each of the battery cells of the first group of battery cells, and wherein, in a cross-sectional view, the vent channel has a rectangular shape.

20. A motor vehicle comprising:
a power-source configured to generate power-source torque; and
a battery pack configured to supply electrical energy to the power-source, the battery pack including:
a first group of battery cells and a neighboring second group of battery cells;
a battery pack enclosure surrounded by an external environment and configured to house each of the first group of battery cells and the second group of battery cells;
a vent channel mounted to the battery pack enclosure and configured to expel high-temperature gases to the external environment separately from each battery cell of the first group of battery cells and divert the high-temperature gases away from other battery cells of the first group of battery cells and from the second group of battery cells, to thereby minimize transfer of the high-temperature gases between the battery cells of the first group of battery cells and from the first group of battery cells to the second group of battery cells and control propagation of a thermal runaway event in the battery pack; and
a valve connected to the vent channel and configured to control expelling of the high-temperature gases from the vent channel to the external environment.
